(19) United States
(12) Patent Application Publication
(10) Pub. No.: US 2024/0318496 A1
(43) Pub. Date: Sep. 26, 2024

(54) TRANSFER APPARATUS BY AIR FLOATING FOR MANUFACTURING OF INSULATED GLAZING UNITS

(71) Applicants: CORNING INCORPORATED, Corning, NY (US); G-ONE AUTOMATION CO., LTD.

(72) Inventor: GEON-HWA LEE, Gwangsan-gu (KR)

(21) Appl. No.: 18/611,288

(22) Filed: Mar. 20, 2024

(30) Foreign Application Priority Data
Mar. 20, 2023 (KR) 10-2023-0036079

(51) Int. Cl. E06B 3/673; B65G 15/28; B65G 43/00; B65G 49/06

(52) U.S. Cl. CPC E06B 3/67365; B65G 15/28; B65G 43/00; B65G 49/065; E06B 3/67321; E06B 3/67326; B65G 2812/16

(57) ABSTRACT

An air-floating transfer apparatus for manufacturing insulated glazing units (“IGUs”). The apparatus includes a frame arranged at a certain angle on one side of a conveyor belt, a support for the frame, and an air pump supplying air to the frame. The frame comprises multiple rows of air blowers that expel air towards one surface of the glass being transported by the operation of the air pump, and between these multiple rows of air blowers, there are arranged multiple rows of exhaust support plates with exhaust holes formed at regular intervals to selectively exhaust air discharged from the air blowers. Additionally, the device includes an opening and closing unit that opens or closes the exhaust holes of the exhaust support plates depending on the thickness of the glass being transported.

### CLAIM OF PRIORITY

This application claims priority to Korea Patent Application No. 10-2023-0036079, titled “Transfer Apparatus by Air Floating for Manufacturing of Insulating Glass,” filed 20 Mar. 2023, the entirety of which is incorporated herein by reference.

### TECHNICAL FIELD

The present invention relates to a transfer apparatus by air floating for manufacturing insulating glazing units (“IGUs”), and more particularly, to a transfer apparatus by air floating for manufacturing IGUs that allows the transfer of glass panes having different thicknesses, without mechanical friction, for the inline production of IGUs.

### BACKGROUND

Recently, there has been a gradual increase in the demand for IGUs due to the improvement of economic conditions, leading to the enhancement of living standards and advancements in manufacturing technology, despite its relatively high cost.

Indeed, driven by the desire of consumers to seek a more comfortable living environment free from noise, demand for IGUs is increasing not only in large buildings but also in small shops and individual residences.

In general terms, is composed of two or more glass panes sealed together as a unit with a certain space between them. Compared to single-pane glass, IGUs minimize indoor energy loss and reduce the decrease in surface temperature of the inner glass, thereby inhibiting condensation even with a decrease in external temperature.

Additionally, IGUs effectively block the transmission of noise between indoor and outdoor environments.

Conventional IGUs include an inner glass facing the building's interior (hereinafter referred to as the first glass), an outer glass forming the building's facade (hereinafter referred to as the second glass), and spacers that maintain a certain distance between the first and second glasses.

Spacers are typically made of aluminum to securely support the separated glass panels.

However, spacers made of aluminum have the disadvantage of significantly reducing insulation effectiveness due to their high thermal conductivity, leading to condensation on the inner and outer surfaces of the glass, which greatly obstructs visibility.

To address these issues, spacers made of synthetic resin have been proposed, such as that disclosed in Korean Registered U.S. Pat. No. 1,021,851, which is disclosed by reference in its entirety.

Spacers made of synthetic resin are suitable for enhancing insulation effectiveness. Thermo Plastic Spacers (“TPS”) containing a desiccant, such as polyisobutylene, are suitable for this purpose.

### SUMMARY

Recently, triple or higher-layered IGUs have been manufactured to enhance the functionality of the IGU. To produce IGUs with three or more layers, spacers are placed between the first or second glass and an intermediate glass, and the glass panes are then assembled into a an IGU. In this process, the relatively thick first and second glass, along with the relatively thin intermediate glass, are sequentially transported inline.

Moreover, there has been a recent trend in using thin glass with thicknesses ranging from 0.5 to 1 mm for the production of IGUs, owing to technological advancements.

In transporting glass panes with different thicknesses inline for IGU production, the glass is inclined at a certain angle and supported by a conveyor (e.g., a conveyor belt) to facilitate transportation. Typically, the conveyor includes multiple casters that contact a primary surface of the glass pane, allowing movement of the glass pane by rotation of the casters.

When the thickness of the glass pane exceeds a certain value, the misalignment of even multiple casters during the transportation process poses no significant problem. Conversely, when transporting thin glass panes, even slight misalignment of casters can easily lead to cracking, posing a significant risk of breakage of the thin glass panes.

Furthermore, direct contact of multiple casters with the primary surface of the glass pane can cause contamination of the glass pane, leading to defects in the final product (e.g., the IGU incorporating the contaminated glass pane).

The present disclosure is conceived in view of the above problems. The technical problem to be solved by the present disclosure, among others, is to provide a transfer apparatus for manufacturing IGUs, which transports the glass panes without mechanical friction by air floating, thereby enabling stable transportation of the thin glass without the risk of contamination, damage, or breakage.

In other words, the technical problem to be solved by the present invention, among others, is to provide a transfer apparatus for manufacturing IGUs, which transports thin glass more stably by air floating, particularly when transporting thin glass, the transportation is performed by air floating, allowing for more stable transportation of thin glass.

In particular, the technical problem to be solved by the present invention, among others, is to provide a transfer apparatus for manufacturing IGUs, which transports thin glass by air floating. Depending on the thickness of the glass being transported, the discharge volume or direction of the supplied air is adjusted, ensuring stable transportation even when the thickness of the transported glass varies, ultimately enabling the production of IGUs with glass panes of various thicknesses.

The tasks of the present invention are not limited to those mentioned above, and other tasks not mentioned can be clearly understood by the following description.

An embodiment of the transfer apparatus for manufacturing IGUs according to the present invention, for addressing the above problems, involves transporting glasses of various thicknesses sequentially supplied for IGU manufacturing. The transfer apparatus includes a frame arranged at a certain angle on one side of the conveyor belt, a support for supporting the frame, and an air pump supplying air to the frame. The frame includes multiple rows of blowing units that receive air from the supply pump and discharge it toward the primary surface of the glass pane being transported due to the operation of the supply pump. Between the multiple rows of blowing units, there is a plurality of exhaust support plates arranged at intervals to selectively exhaust air discharged from the blowing units, with each exhaust support plate having exhaust holes. The transfer apparatus may further include an opening and closing unit to open and close the exhaust holes of the exhaust support plates according to the thickness of the glass pane being transported at a particular instant.

In this case, the blowing units receive air from the operation of the air pump and are coupled and arranged on the leader side of the air distribution member to ensure uniform distribution of air. The blowing units can be composed of a blowing support plate with multiple blowing holes formed in the transverse direction, which are in communication with the air distribution member.

Furthermore, the opening and closing unit may comprise a cylinder driven by an input signal, a rod that moves up and down by the operation of the cylinder at regular intervals, multiple links coupled to the rod with rotational capability at one end, and multiple opening and closing plates coupled to the other end of the links, with one side being rotatable and the other side being coupled to the exhaust support plate and rotatable.

In this context, the opening and closing unit may include a support bracket installed on at least one surface of at least one exhaust support plate among the multiple exhaust support plates to guide the linear lifting of the rod, and a pair of guide rollers installed on the support bracket to guide the linear lifting of the rod.

It may be desirable for the opening and closing unit to open the exhaust holes of the exhaust support plate when the thickness of the glass pane being transported is below a preset thickness (e.g., predetermined thickness) and to close the exhaust holes of the exhaust support plate when the thickness of the glass pane being transported is equal to or above the set thickness.

Other specific details of the present invention are included in the detailed description and drawings.

According to the embodiments of the present disclosure, the transfer apparatus for manufacturing insulating glass by air floating provides the effect of transporting glass panes for the production of IGUs without mechanical friction, thereby allowing the glass panes to be transported stably without concerns of contamination, damage, or breakage.

In particular, when transporting thin glass panes, the effect of more stable transportation is achieved through air floating, ensuring the thin glass pane is transported more securely.

Especially, with the transfer apparatus for manufacturing IGUs according to the embodiments of the present invention, the air supply volume or direction can be adjusted based on the thickness of the glass pane being presently transported by air floating. This ensures stable transportation even when dealing sequentially with glass panes of different thicknesses, ultimately enabling the production of IGUs that include panes with differing thicknesses.

The effects of the present disclosure are not limited to the examples provided above and encompass a broader range of effects as described in this specification.

### BRIEF DESCRIPTION OF THE DRAWINGS

In the Drawings:

FIG. 1 is a block diagram outlining the configuration of an in-line IGU manufacturing system with a transfer apparatus by air floating for manufacturing of IGUs according to an embodiment of the present disclosure;

FIG. 2 illustrates the configuration of FIG. 1;

FIG. 3 is a front view of the transfer apparatus by air floating for manufacturing of IGUs according to an embodiment of the present disclosure, showing the perspective with the exhaust port open;

FIG. 4 is a rear view of FIG. 3;

FIG. 5 is a side view of FIG. 3;

FIG. 6 is an enlarged view of a portion showing the exhaust port open for transferring thin glass panes by the transfer apparatus by air floating for manufacturing of IGUs according to an embodiment of the present disclosure;

FIG. 7 is a front view of the transfer apparatus by air floating for manufacturing of IGUs according to an embodiment of the present disclosure, showing the perspective with the exhaust port closed;

FIG. 8 is a rear view of FIG. 7;

FIG. 9 is a side view of FIG. 7; and

FIG. 10 is an enlarged view of a portion showing the exhaust port closed for transferring thick glass panes having a thickness equal to or above the set thickness by the transfer apparatus by air floating for manufacturing of IGUs according to an embodiment of the present disclosure.

### DETAILED DESCRIPTION

The advantages and features of the present invention, as well as the methods for achieving them, will be detailed along with the accompanying drawings in the exemplary embodiments provided below. However, it should be noted that the present disclosure is not limited to the embodiments disclosed below but can be implemented in various other forms. The present disclosure is defined only by the scope of the claims. Throughout the specification, the same reference numerals denote the same components.

Therefore, in some embodiments, well-known process steps, well-known structures, and well-known techniques are not specifically described to avoid ambiguity in interpreting the present disclosure.

The terminology used in this specification is for describing embodiments and is not intended to limit the claims. In this specification, the singular includes the plural unless specifically mentioned otherwise. The terms “includes,” “including,” “comprises” and/or “comprising” used in the specification are intended to denote the inclusion of one or more other components, steps, and/or operations in addition to those specifically mentioned, without excluding the presence or addition of other components, steps, and/or operations. Additionally, “and/or” encompasses each of the mentioned items and any combination thereof.

Furthermore, the embodiments described in this specification will be elucidated with reference to schematic views, cross-sectional views, side views, and/or block diagrams, which are embodiments of the disclosure. Therefore, the form of the exemplary views may be modified due to manufacturing techniques and/or permissible tolerances. Thus, the embodiments of the present disclosure include variations in form generated by manufacturing processes, rather than being limited to the specific forms depicted. Additionally, in each drawing of the embodiments of the present disclosure, the components may be slightly enlarged or reduced for convenience of description.

Below, the detailed description of the air floating transfer device for manufacturing insulating glass according to the embodiments of the present disclosure will be provided based on the attached example diagrams.

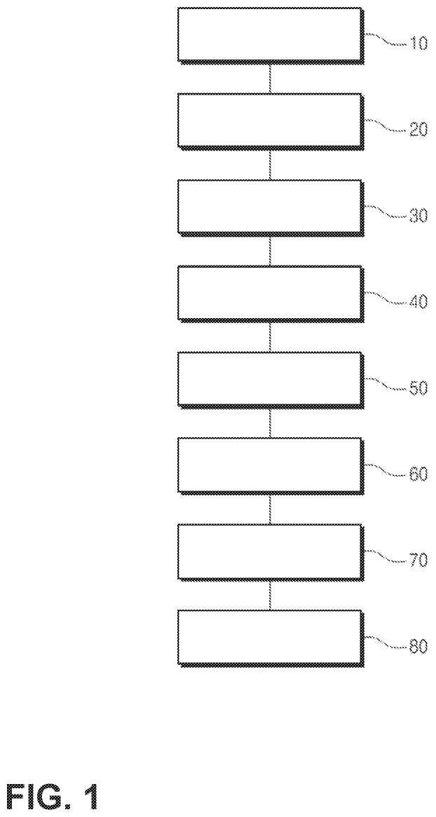

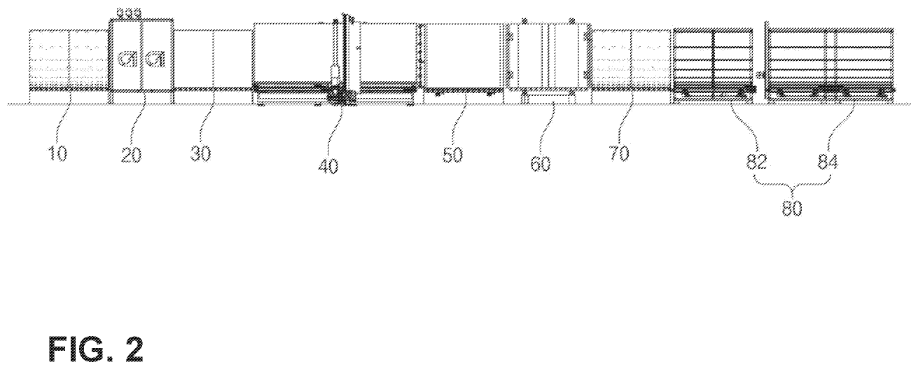

FIG. 1 depicts a schematic block diagram illustrating the configuration of an in-line IGU manufacturing system employing the air floating transfer apparatus according to the embodiments of the present disclosure, while FIG. 2 shows the detailed configuration of FIG. 1.

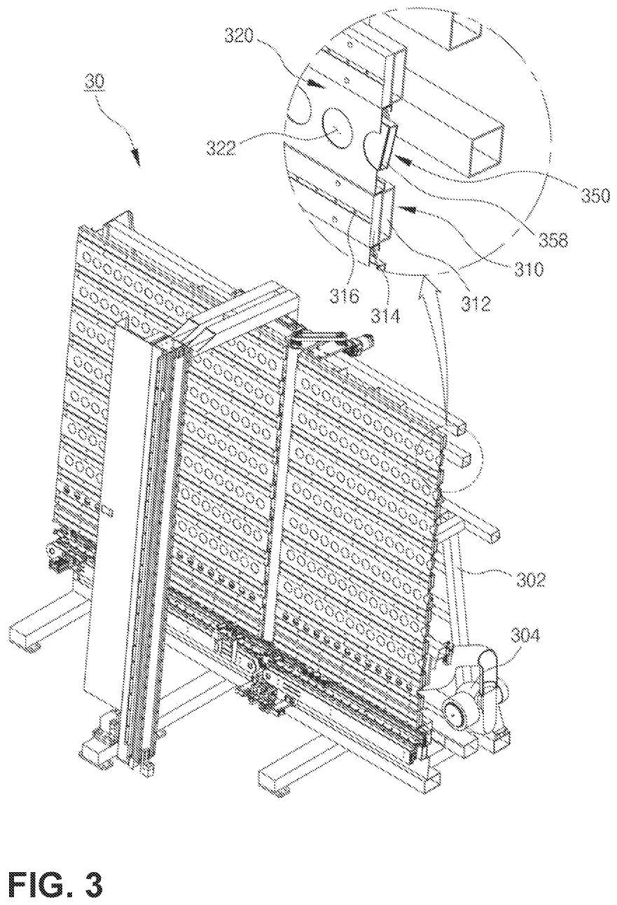

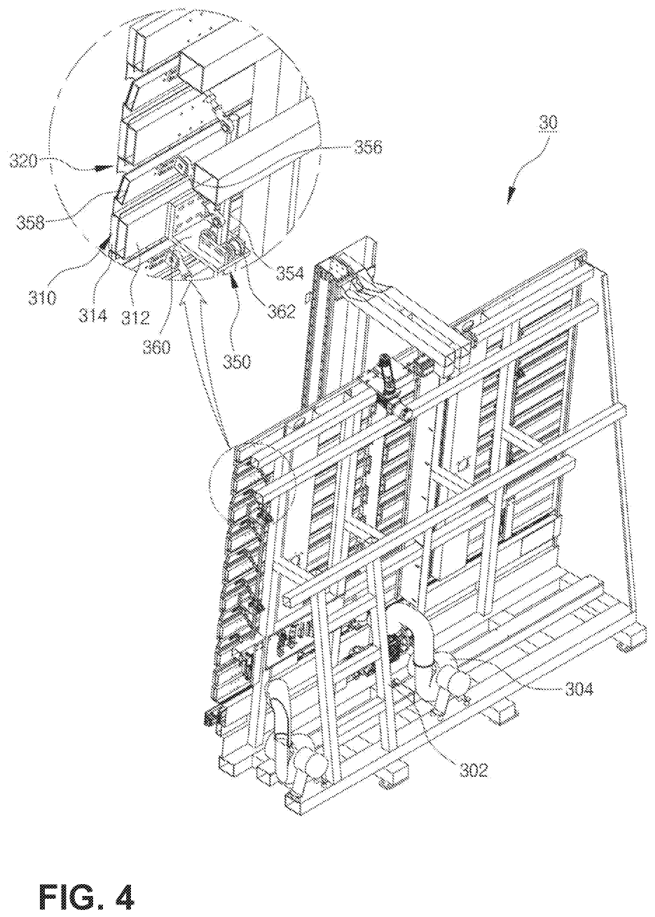

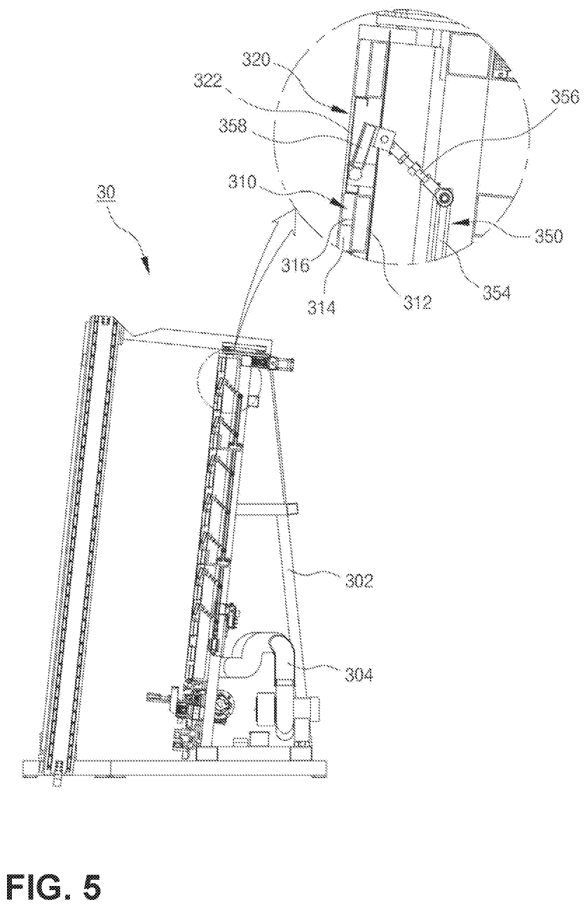

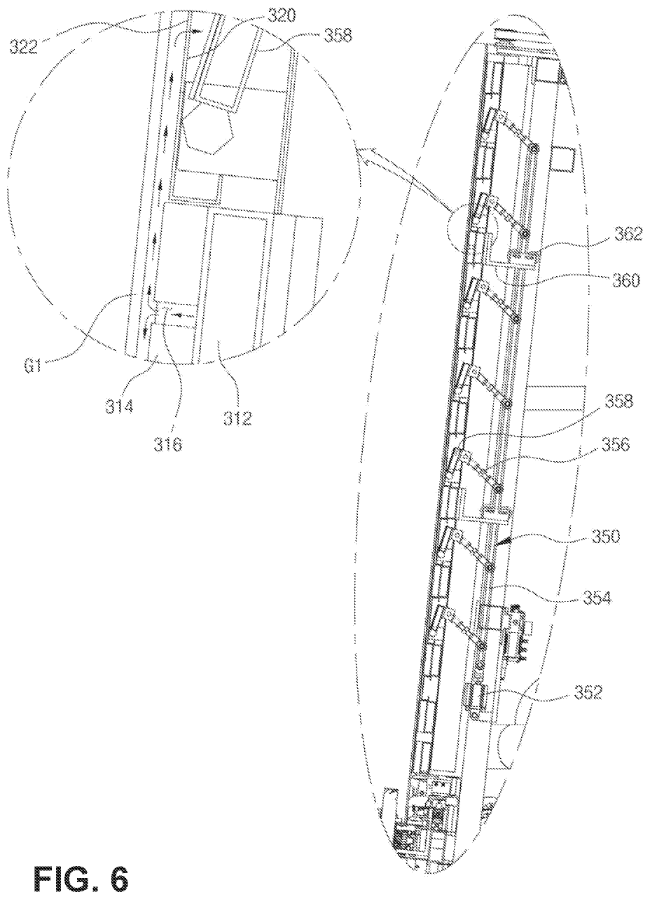

Furthermore, FIG. 3 illustrates a perspective view of the air floating transfer apparatus for manufacturing IGUs according to the embodiments of the present disclosure, showing the apparatus with the exhaust port in an open state. FIG. 4 presents a rear perspective view of FIG. 3, while FIG. 5 shows a side view of FIG. 3. FIG. 6 provides an enlarged view of a specific portion of the air floating transfer apparatus for manufacturing IGUs according to the embodiments of the present disclosure, with the exhaust port open.

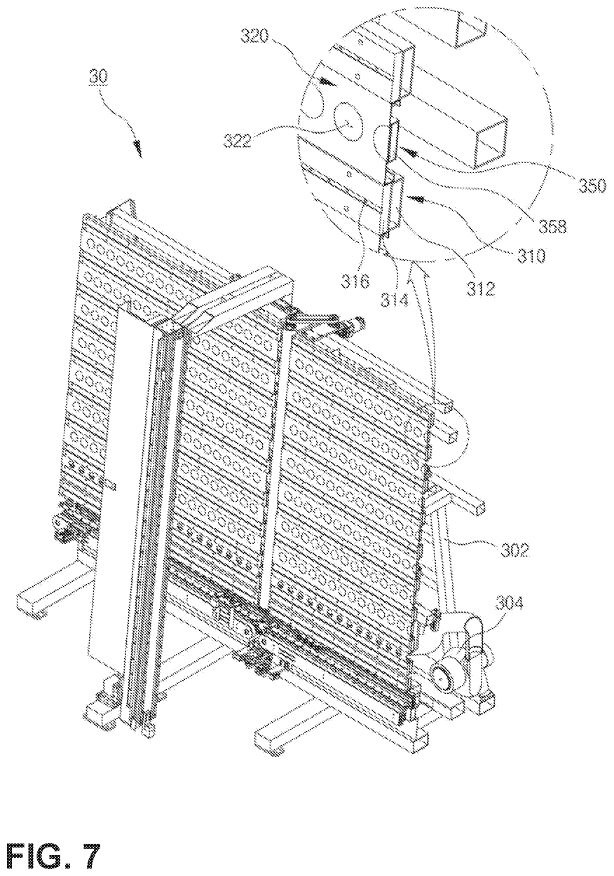

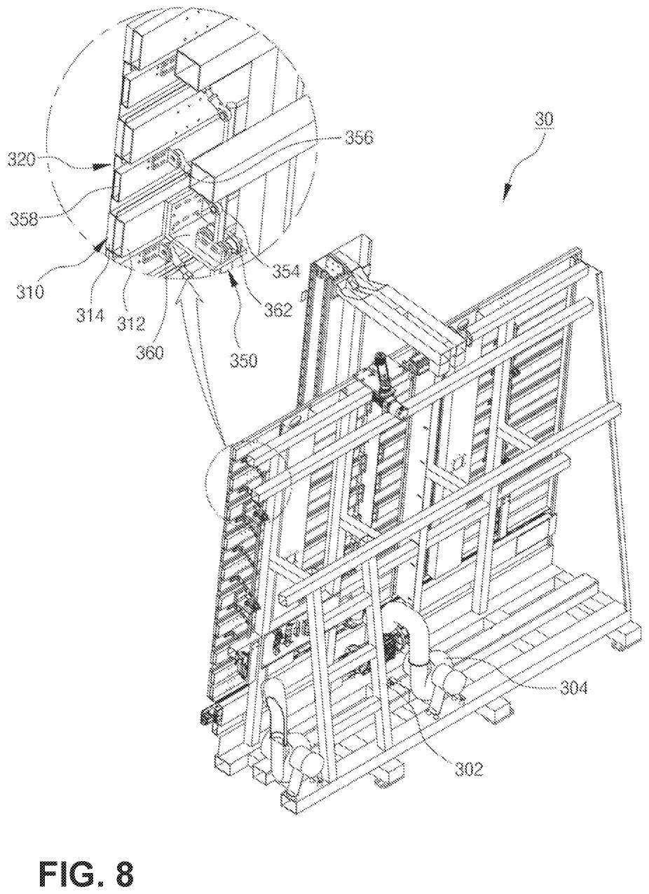

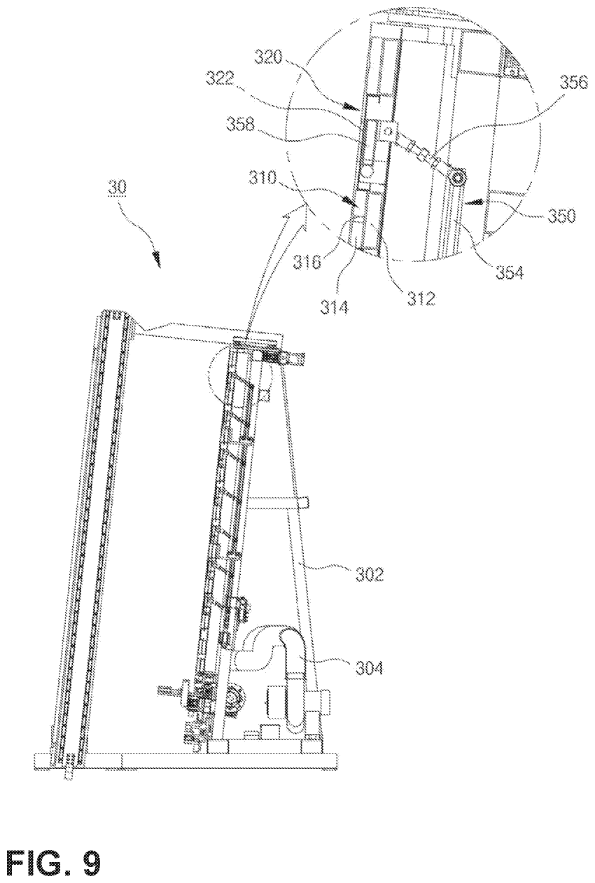

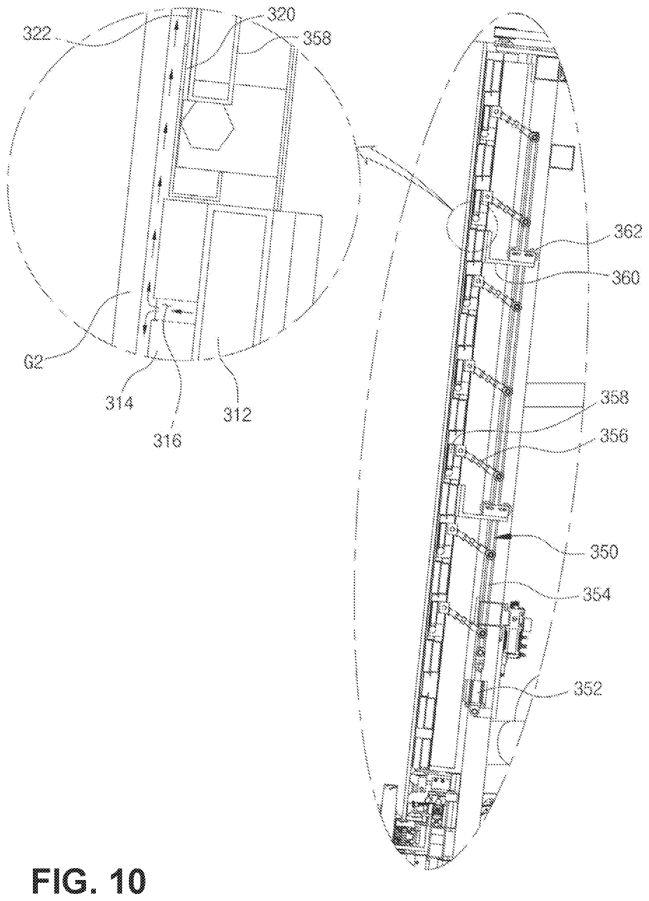

Additionally, FIG. 7 illustrates a perspective view of the air floating transfer apparatus for manufacturing IGUs according to the embodiments of the present disclosure, with the exhaust port in a closed state. FIG. 8 presents a rear perspective view of FIG. 7, while FIG. 9 shows a side view of FIG. 7. FIG. 10 provides an enlarged view of a specific portion of the air floating transfer apparatus for manufacturing IGUs according to the embodiments of the present disclosure, with the exhaust port closed.

Firstly, as depicted in FIGS. 1 and 2, the manufacturing system for IGUs employing the air floating transfer apparatus according to the embodiments of the present disclosure may include a glass pane supply unit 10 configured to supply glass panes of set thicknesses for forming inner glass, outer glass, or intermediate glass of the IGU to be formed in a predetermined sequence controlled by control signals. Any one of the glass planes may be a single glass layer or a laminate of more than one glass layers. Such laminates may include glass layers of the same or differing thicknesses with an interlayer, which may be polymeric, disposed between the glass layers. The glass panes subsequently combined into an IGU may have different compositions. The glass panes subsequently combined into an IGU may have different thicknesses.

Here, the glass pane supply unit 10 can supply glass panes that have been cut to the desired size (e.g., dimensions such as length and width). In embodiments, the glass panes have at least one edge, a first primary surface, and a second primary surface. The first primary surface and the second primary surface face in opposite directions.

Furthermore, the IGU manufacturing system may comprise a washing and drying unit 20 for sequentially washing and drying the glass panes supplied from the glass supply unit 10, them, at least one transfer apparatus 30, a spacer coating unit 40 for applying a spacer (e.g., thermosplastic spacer, TPS) to one of the primary surfaces of the transferred glass pane, and an inspection unit 50 for inspecting the appearance of the glass panes.

Additionally, the IGU manufacturing device may further comprise an alignment unit 60 for realigning (e.g., rotating) any of the glass panes to be bonded together that need realignment (e.g., those glass panes with a low emissivity coating), and a bonding unit 70 for bonding two or more of the glass panes together with the spacer(s) separating adjacent glass panes and adding a gas (e.g., argon) within the space(s) between the adjacent glass panes. The IGU manufacturing system may further comprise a sealing unit 80 for applying a sealing material (e.g., a secondary sealant) to the edges of the IGU supplied from the bonding unit 70.

The washing and drying unit 20 sprays washing water onto the glass panes sequentially supplied from the glass panes supply unit 10, washes them, and then dries them using hot air.

Thus, the glass panes, whose primary surfaces have been washed and dried by the washing and drying unit 20, are transferred to the spacer coating unit 40 by the transfer apparatus 30.

A conveyor belt for transferring glass panes may be installed on the lower part of the transfer apparatus 30, which further includes an air floating system to air float the while being transferred. Detailed explanation of this will be provided later.

The air-floating transfer apparatus 30 for manufacturing IGUs according to an embodiment of the present disclosure may comprise, as shown in FIGS. 3 to 10, a frame arranged at a certain angle on one side of a conveyor belt, support brackets 302 supporting the frame, and an air pump 304 supplying air to the frame. As described herein, the certain angle of the frame is configured in a near-vertical configuration, but slightly tilted. In this configuration, the certain angle is tailored to enable the thin glass to be actuated by the blowing and exhaust to provide a float, with a pushing/pulling or positive air pressure/negative air pressure actuating on a major surface of the thin glass pane. As non-limiting examples, the angle is in the range of 15 degrees to 2 degrees, or from 13 degrees to 5 degrees, or from 10 to about 7 degrees, or from about 12 to about 4 degrees.

Here, the frame may include multiple rows of air blowing units 310 that receive air from the air pump 304 and discharge it toward one side of the glass pane being conveyed, and multiple rows of exhaust support plates 320 arranged between the air blowing units 310 with a certain gap to selectively exhaust air discharged from the air blowing units 310 through exhaust holes 322.

The air blowing units 310 and the exhaust support plates 320 may be installed in a transverse direction, with the exhaust support plates 320 positioned to cross in the longitudinal direction between the air blowing units 310.

The air blowing units 310 may comprise an air distribution member 312 that allows air to be evenly distributed when air is introduced by the operation of the air pump 304, and multiple airflow holes 316 formed in a transverse direction on a blowing support plate 314 connected and arranged at the leading edge of the air distribution member 312.

Furthermore, as described earlier, the exhaust support plates 320 may have multiple exhaust holes 322 formed in the transverse direction and may be positioned between adjacent blowing support plates 314.

The air-floating transfer apparatus 30 for manufacturing IGUs according to embodiments of the present disclosure may further include a control mechanism 350 for opening and closing the exhaust holes 322 of the exhaust support plates 320 based on the thickness of the particular glass pane being transported.

In some embodiments, the control mechanism 350 for opening and closing the exhaust holes 322 of the exhaust support plates 320 based on the thickness of the particular glass pane being transported can be varied to adjust for glasses of different areal dimensions (e.g. relative dimension and/or sizes of the major surface of the thin glass pane), or to adjust based on the thickness (e.g. 0.3 mm thick pane of thin glass is lighter than a 1.6 mm thick pane of thin glass).

In some embodiments the air floating transfer apparatus is configured to change the opening and closing of the exhaust holes and the air blowing units/air flow holes, such that the apparatus is configured to provide a supported, controlled transport of the thin glass along the conveyance device (e.g. rollers, casters, conveyor or the like along at least one edge of the glass), while retaining the thin glass in a ‘non-touch’ but securely supported position, in relation to the major surface of the thin glass relative to the corresponding surface of the frame.

The thin glass referred to herein is large in size, and configured for architectural applications (e.g. dimensions of 3 ft. by 5 ft, 5 ft. by 7 ft, 7 for by 10 ft, or even larger). Conveying dimensionally large, thin sheets of glass is particularly challenging when the thin glass has already been washed and dried, so the large, thin glass conveyance is configured in a non-touch manner, so as to not mark, blemish, or dirty the major surfaces of the thin glass. Moreover, the thin glass is conveyed in a particular position (e.g. vertical or near vertical) in order to configure the glass for downstream processing (deposition of spacer materials, coatings, and/or the like).

For example, if the dimensionally large (architectural applications) and cross-sectionally thin, thin glass is conveyed in an uncontrolled manner and in an unsupported way, there are several (or more deleterious effects that can result, including, to name a few: the thin glass could fall off the conveyor, be marked or blemished, have impact initiation sites along the major surface, undergo significant flexural movement during conveyance such that (a) the glass bends and breaks and/or (b) the downstream processing/spacer application is ineffective and/or results in defective spacer-applied thin glass parts.

The control mechanism 350 may include a cylinder 352 driven by input signals, a rod 354 that is lifted by the operation of the cylinder 352 at predetermined intervals, multiple links 356 coupled to the rod 354 for rotation, and multiple opening and closing plates 358 coupled to the links 356 for rotation.

The opening and closing plates 358 may be hinged at the lower end to the rear side of the exhaust support plates 320 and hinged at the upper end to the links 356 for rotation.

Therefore, as the rod 354 is lifted, the multiple links 356 rotate by a certain angle, causing the opening and closing plates 358 coupled to them to also rotate by a certain angle. As a result, as shown in FIGS. 6 and 10, the exhaust holes 322 of the exhaust support plates 320 are opened or closed accordingly.

In this case, the rod 354 should be lifted without deviation in the linear direction to ensure the accurate opening and closing of the opening and closing plates 358 for the exhaust holes 322. Therefore, the control mechanism 350 may include support brackets 360 and guide rollers 362 to guide the linear lifting of the rod 354.

Here, the support brackets 360 may be installed on at least one of the rear surfaces of the multiple exhaust support plates 320, and they may include a pair of guide rollers 362 installed on the support brackets 360 to guide the linear lifting of the rod 354.

Meanwhile, the cylinder 352 of the control mechanism 350 can be operated by control signals, which can be hydraulic or pneumatic, or electronic such as solenoid valves, or mechanical such as ball screws, as long as they can lift the rod 354 within a certain range as conventionally known.

This cylinder 352, controlled by set control signals from the control unit, can raise or lower the rod 354. For instance, depending on the thickness of the glass pane being transported, the rod 354 can be raised or lowered.

For example, when the glass pane being transported is thinner than the set thickness, as shown in FIGS. 3 to 6, the control unit can input a lowering signal to the cylinder 352 so that the opening and closing plates 358 of the control mechanism 350 open the exhaust holes 322 of the exhaust support plates 320.

In this way, when the exhaust holes 322 of the exhaust support plates 320 are open, thin glass panes, such as glass panes with a thickness of about 0.5 mm to 1 mm, being transported, as depicted in FIG. 6, the airflow through the airflow holes 316 can air float the transported thin glass pane G1, ensuring that it is transported without contacting the frame. In embodiments, the thickness of the thin glass pane G1 is less than 0.3 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm. 2.7 mm. 2.8 mm, 2.9 mm, 3.0 mm, or within any range bound by any two of those values (e.g., from 0.3 mm to 1.0 mm, from 0.4 mm to 0.9 mm, from 0.4 to 1.3 m, from 0.5 to not greater than 1.6 . . . , from 0.6 mm to 2.2 mm, from 0.3 mm to 2.0 mm, and so on).

The airflow causing the thin glass pane G1 to air float is directly exhausted from the frame surface through the exhaust holes 322 formed in the exhaust support plates 320, allowing the transported thin glass G1 to be spaced apart from the frame with a certain distance, ensuring a non-contact transport.

However, when the exhaust holes 322 of the exhaust support plates 320 are open, and a glass pane with a thickness of more than the set thickness, e.g., over 5 mm, is being transported, thick glass pane may not be adequately air-floated by the airflow through the airflow holes 316, causing the air to escape through the exhaust holes 322. Moreover, the venturi effect during the air escaping through the exhaust holes 322 may generate suction force, inadvertently causing the glass pane to adhere to the frame. In embodiments, the thickness of the thick glass pane G2 is 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, 5.0 mm, or within any range bound by any two of those values (e.g., from 2.0 mm to 5.0 mm, from 3.9 mm to 4.5 mm, and so on). Moreover, thicker glass panes may be utilized, including glass panes having a thickness of at least 6 mm, or at least 8 mm, or at least 10 mm thick, or thicker. The thicknesses of the thin glass pane G1 and the thick glass pane G2 provided herein are just exemplary, and in principle the air-floating transfer device 30 can operate in the manner herein described as long as the thickness of the thin glass pane G1 is less than the thickness of the thick glass pane G2, and the exhaust holes 322 are open during conveyance of the thin glass pane G1 and closed during conveyance of the thick glass pane G2.

Therefore, when transporting a glass pane with a thickness exceeding the set thickness, it is preferable to operate the control mechanism 350 to close the exhaust holes 322 of the exhaust support plates 320, as depicted in FIG. 10, to ensure proper transport.

In other words, when the transported glass pane exceeds the set thickness, the control unit transmits this signal to the cylinder 352. As a result, the cylinder 352 is actuated to raise the rod 354. At regular intervals on the rod 354, each link 356 coupled to a pivotable manner is rotated by a certain angle, causing the links 356 and the opening and closing plates 358 coupled to both ends of the exhaust support plates 320 to rotate at an angle, thereby covering the exhaust holes 322 of the exhaust support plates 320.

Thus, when the exhaust holes 322 of the exhaust support plates 320 are covered, and glass panes G2 thicker than the set thickness is being transported, the airflow through the airflow holes 316 of the airflow support plates 314 air floats the glass G2 without being exhausted through the frame surface (e.g., the exhaust holes 322). Instead, exhaust occurs only through the gaps between the frame and the thick glass pane G2, allowing the thick glass pane G2 thicker than the set thickness to be adequately air-floated during transport.

As described above, with the air floating transfer apparatus 30 for IGU production according to the embodiment of the present disclosure, glass pane transport for IGU production can be achieved through air-floating without mechanical friction. This allows stable glass pane transport without the risk of contamination, damage, or breakage.

In summary, when transporting thin glass panes, air floating enables more stable transport, providing effective transportation without concerns of contamination, damage, or breakage.

In particular, with the air floating transfer apparatus 30 for IGU production according to embodiments of the present disclosure, the glass pane being transported is air floated. Depending on the thickness of the transported glass pane, the exhaust volume or direction of the supplied air can be adjusted. This ensures stable transport even for glass panes of different thicknesses, ultimately allowing for the production of IGUs including glass panes of various thicknesses.

One skilled in the art to which the present disclosure pertains would understand that the embodiments can be implemented in various specific forms without departing from its technical essence or essential features. Therefore, the embodiments described above should be understood as exemplary rather than limiting in all aspects. The scope of the disclosure is defined by the claims appended hereto, and all modifications or variations derived from the meaning and scope of the claims and the concept of equivalents are to be included within the scope of the disclosure.

According to a first aspect of the present disclosure, an air-floating transfer apparatus for transporting glass panes of various thicknesses sequentially supplied for IGU manufacturing, comprises: a frame arranged at a certain angle on one side of a conveyor belt and supported by support brackets, and an air pump supplying air to the frame, wherein the frame comprises: (i) multiple rows of blower units that receive air from the air pump and positioned to expel it toward one primary surface of a glass pane being transported by operation of the blower pump, (ii) multiple rows of exhaust support plates placed between the rows of blower units to selectively exhaust air expelled from the blower units through exhaust holes formed at regular intervals, and (iii) an opening and closing unit to open or close the exhaust holes of the exhaust support plates as a function of the thickness of the glass pane being transported.

According to a second aspect of the present disclosure, the air-floating transfer apparatus of claim 1, wherein the blower units comprise: (i) an air distribution member that allows air to be evenly distributed by the operation of the air pump, and (ii) multiple blower holes formed in a transverse direction and coupled to and arranged on the leading edge of the air distribution member, wherein the blower holes communicate with the air distribution member, forming a blower support plate.

According to a third aspect of the present disclosure, the air-floating transfer apparatus of any one of the first through second aspects is presented, wherein the opening and closing unit comprises: (i) a cylinder driven by input signals, (ii) a rod that ascends or descends a certain distance by the operation of the cylinder, (iii) multiple links coupled to the rod allowing rotation, and (iv) multiple opening and closing plates, each having one end pivotally coupled to the respective link and the other end pivotally coupled to the exhaust support plate.

According to a fourth aspect of the present disclosure, the air-floating transfer apparatus of the third aspect is presented, wherein the opening and closing unit comprises: (i) at least one support bracket installed on the surface of at least one of the plurality of exhaust support plates to guide the linear movement of the rod, and (ii) a pair of guide rollers installed on the support bracket to guide the linear movement of the rod.

According to a fifth aspect of the present disclosure, the air-floating transfer apparatus of any one of the first through fourth aspects is presented, wherein the opening and closing unit (i) opens the exhaust holes of the exhaust support plate when the glass pane being transported is below the set thickness and (ii) closes the exhaust holes of the exhaust support plate when the glass pane being transported is above the set thickness.

According to a sixth aspect of the present disclosure, an air-floating transfer apparatus comprises: (a) a conveyor belt configured to convey glass; (b) an air pump configured to supply air; (c) multiple rows of air blowing units configured to receive the air from the air pump and discharge the air toward a primary surface of the glass pane; and (d) multiple rows of exhaust support plates, each (i) comprising exhaust holes and (ii) arranged between two of the multiple rows of air blowing units so that the multiple rows of air blowing units and the multiple rows of exhaust support plates alternate position moving away from the conveyor belt, the multiple rows of exhaust support plates configured to selectively (i) open to accept air discharged from the multiple rows of air blowing units through the exhaust holes or (ii) close to not accept the air; wherein, the multiple rows of exhaust supports plates and the multiple rows of air blowing units form a substantially planar glass facing surface, the substantially planar glass facing surface positioned at a predetermined angle from vertical.

According to a seventh aspect of the present disclosure, the air-floating transfer apparatus of the sixth aspect further comprises: support brackets that support the multiple rows of exhaust support plates and the multiple rows of air blowing units.

According to an eighth aspect of the present disclosure, the air-floating transfer apparatus of any one of the sixth through seventh aspects is presented, wherein each of the multiple rows of air blowing units comprise (i) an air distribution member configured to evenly distribute air from the air pump, (ii) a blowing support plate disposed at a glass-facing edge of the air distribution member, and (iii) multiple airflow holes through the blowing support plate.

According to a ninth aspect of the present disclosure, the air-floating transfer apparatus of any one of the sixth through eighth aspects is presented, wherein each of the exhaust support plates comprise multiple of the exhaust holes.

According to a tenth aspect of the present disclosure, the air-floating transfer apparatus of any one of the sixth through ninth aspects further comprises: a control mechanism for selectively opening and closing the exhaust holes of the exhaust support plates as a function of a thickness of the glass pane to be conveyed on the conveyor belt.

According to an eleventh aspect of the present disclosure, the air-floating transfer apparatus of the tenth aspect is presented, wherein (i) the control mechanism is configured to open the exhaust holes of the exhaust support plates when the glass pane to be conveyed is thinner than a set thickness, and (ii) the control mechanism is configured to close the exhaust holes of the exhaust support plates when the glass pane to be conveyed is thicker than a set thickness.

According to a twelfth aspect of the present disclosure, the air-floating transfer apparatus of the eleventh aspect is presented, wherein the control mechanism comprises: (a) a cylinder configured to be driven by input signals; (b) a rod that is manipulated by operation of the cylinder; (c) multiple links coupled to the rod for rotation; and (d) multiple opening and closing plates, each of which is coupled to (i) a different one of the exhaust support plates and (i) at least one of the multiple links.

According to a thirteenth aspect of the present disclosure, the air-floating transfer apparatus of the twelfth aspect is presented, wherein each of the multiple opening and closing plates are hinged at a lower end to a side of the exhaust support plate configured to face away from the glass pane and at an upper end to the at least one of the multiple links.

According to a fourteenth aspect of the present disclosure, the air-floating transfer apparatus of any one of the twelfth through thirteenth aspects is presented, wherein as the rod is lifted via movement of the cylinder, the multiple links rotate and thereby cause the multiple opening and closing plates to rotate as well.

According to a fifteenth aspect of the present disclosure, the air-floating transfer apparatus of the fourteenth aspect is presented, wherein rotation of the multiple opening and closing plates selectively opens or closes the exhaust holes of the exhaust support plates.

According to a sixteenth aspect of the present disclosure, the air-floating transfer apparatus of any one of the twelfth through fifteenth aspects is presented, wherein the control mechanism further comprises: (i) support brackets coupled to the surface of each of the exhaust support plates positioned to face away from the glass pane; and (ii) guide rollers installed on the support brackets to guide the manipulation of the rod.

According to a seventeenth aspect of the present disclosure, the air-floating transfer apparatus of any one of the twelfth through sixteenth aspects is presented, wherein the control mechanism further comprises a control unit configured send the input signals to the cylinder to manipulate the rod as a function of a thickness of the glass pane to be conveyed by the conveyor.

According to an eighteenth aspect of the present disclosure, the air-floating transfer apparatus of the seventeenth aspect is presented, wherein the control unit is configured to send the input signal to the cylinder to manipulate the rod so that the exhaust holes of the exhaust support plates are open when the glass pane to be conveyed is thinner than a set thickness.

According to a nineteenth aspect of the present disclosure, the air-floating transfer apparatus of the eighteenth aspect is presented, wherein the control unit is configured to send the input signal to the cylinder to manipulate the rod so that the exhaust holes of the exhaust support plates are closed when the glass pane to be conveyed is thicker than the set thickness.

According to a twentieth aspect of the present disclosure, a method of conveying glass panes comprises: (a) a thin glass pane conveyance step comprising conveying a thin glass pane on the air-floating transfer apparatus of any one of claims 6-20, with an edge of the thin glass pane on the conveyor belt, and a primary surface of the thin glass pane tilted at an angle deviating from vertical facing the multiple rows of air blowing units and the multiple rows of exhaust support plates, wherein, during the thin glass pane conveyance step, (i) the air pump is supplying air, (ii) the air blowing units are receiving the air from the air pump and discharging the air toward the primary surface of the thin glass pane, (iii) the exhaust holes of the exhaust support plates are open, (iv) the air discharged from the air blowing units separate the thin glass pane from the air blowing units and the exhaust support plates, and (v) a portion of the air discharged from air blowing units flow between the thin glass pane and the exhaust support plate and into the exhaust holes; (b) a closing step comprising closing the exhaust holes of the exhaust support plates after the thin glass pane has cleared the air-floating transfer apparatus; (c) a thick glass pane conveyance step comprising conveying a thick glass pane, which is thicker the thin glass pane, on the air-floating transfer apparatus, with an edge of the thick glass pane on the conveyor belt, and a primary surface of the thick glass pane tilted at an angle deviating from vertical facing the multiple rows of air blowing units and the multiple rows of exhaust support plates, wherein, during the thick glass conveyance step, (i) the air pump is supplying air, (ii) the air blowing units are receiving the air from the air pump and discharging the air toward the primary surface of the thick glass pane, (iii) the exhaust holes of the exhaust support plates are closed, (iv) the air discharged from the air blowing units separate the thick glass pane from the air blowing units and the exhaust support plates, and (v) the air discharged from air blowing units flow primarily between the thick glass pane and the multiple rows of air blowing units and the multiple rows of exhaust support plates without flowing through the exhaust holes; and (d) an opening step comprising opening the exhaust holes of the exhaust support plates after the thick glass pane has cleared the air-floating transfer apparatus.

According to a twenty-first aspect of the present disclosure, the method of the twentieth aspect is presented, wherein the thickness of thin glass pane is within a range of from 0.3 mm to 2.0 mm.

According to a twenty-second aspect of the present disclosure, the method of any one of the twentieth through twenty-first aspects is presented, wherein the thickness of the thick glass pane is greater than 5 mm.

According to a twenty-third aspect of the present disclosure, the method of any one of the twentieth through twenty-first aspects is presented, wherein the thickness of the thick glass pane within a range of from 2.0 mm to 5.0 mm.

According to a twenty-fourth aspect of the present disclosure, a method of conveying glass panes of differing thicknesses comprises: (a) a thin glass pane conveyance step comprising: (i) conveying, with a transfer apparatus, a thin glass pane comprising a thickness less than a preset thickness by disposing an edge of the thin glass pane on a conveyor belt, (ii) moving the conveyor belt with the thin glass pane thereupon, (iii) directing air toward a primary surface of the thin glass pane with sufficient volume so that the primary surface of the thin glass pane does not touch a solid surface and the primary surface of the thin glass pane floats while moving upon the air, and (iv) exhausting a portion of the volume of the air through exhaust holes facing the primary surface of the thin glass pane; (b) after the thin glass pane has cleared the transfer apparatus, a closing step comprising closing the exhaust holes; (c) a thick glass pane conveyance step comprising: (i) conveying, with the transfer apparatus, a thicker glass pane comprising a thickness greater than a preset thickness by disposing an edge of the thick glass pane on the conveyor belt, (ii) moving the conveyor belt with the thick glass pane thereupon, and (iii) directing air toward a primary surface of the thick glass pane with sufficient volume so that the primary surface of the thick glass pane does not touch a solid surface and the primary surface of the thick glass pane floats while moving upon the air; and (d) after the thick glass pane has cleared the transfer device, an opening step comprising opening the exhaust holes.

According to a twenty-fifth aspect of the present disclosure, the method of the twenty-fourth aspect is presented, wherein the volume of air directed to the primary surface of the thin glass pane during thin glass pane conveyance step is substantially the same as the volume of air directed to the primary surface of the thick glass pane during the thick glass pane conveyance step.

According to a twenty-sixth aspect of the present disclosure, the method of any one of the twenty-fourth through twenty-fifth aspects is presented, wherein the thickness of thin glass pane is within a range of from 0.3 mm to 2.0 mm.

According to a twenty-seventh aspect of the present disclosure, the method of any one of the twenty-fourth through twenty-sixth aspects is presented, wherein the thickness of the thick glass pane within a range of from 2.0 mm to 5.0 mm.

According to a twenty-eighth aspect of the present disclosure, a system for manufacturing IGUs comprises: (i) a glass pane supply unit configured to supply glass panes of set thicknesses for forming inner glass, outer glass, or intermediate glass of an IGU in a predetermined sequence controlled by control signals; (ii) a washing and drying unit downstream of the glass pane supply unit configured to sequentially wash and dry the glass panes supplied from the glass pane supply unit; and (iii) the air-floating transfer apparatus of any one of claims 1-19 downstream of the washing and drying unit.

According to a twenty-ninth aspect of the present disclosure, the system of the twenty-eighth aspect further comprises: a spacer coating unit downstream of the air-floating transfer apparatus configured to apply sealant material as a spacer to one or more of the supplied glass panes.

According to a thirtieth aspect of the present disclosure, the system of the twenty-ninth aspect further comprises: an inspection unit downstream of the spacer coating unit configured to inspect the glass panes.

According to a thirty-first aspect of the present disclosure, the system of the thirtieth aspect further comprises: (i) an alignment unit configured to realign any of the glass panes to be bonded together that need realignment; (ii) a bonding unit configured to bond two or more of the glass panes together with a space between adjacent glass panes and add a gas in the space, thus forming an IGU; and (iii) a sealing unit configured to apply a secondary sealant onto the IGU.

It should be understood that any of the thirty-one aspects described above can be combined with any other of the thirty-one aspects described above.

### Symbol Explanation

10: Glass pane supply unit
20: Washing and drying unit
30: Transfer apparatus
40: Spacer coating unit
50: Inspection unit
60: Alignment unit
70: Bonding unit
80: Sealing unit
302: Support brackets
304: Air pump
310: Air blowing unit
312: Air distribution member
314: Blowing support plate
316: Airflow hole
320: Exhaust support plate
322: Exhaust hole
350: Control mechanism
352: Cylinder
354: Rod
356: Link
358: Opening and closing plate
360: Support bracket
362: Guide roller

1. An air-floating transfer apparatus for transporting glass panes of various thicknesses sequentially supplied for IGU manufacturing, comprising:
a frame arranged at a certain angle on one side of a conveyor belt and supported by support brackets, and an air pump supplying air to the frame, wherein the frame comprises:
multiple rows of blower units that receive air from the air pump and positioned to expel it toward a primary surface of a glass pane being transported by operation of the blower pump,
multiple rows of exhaust support plates placed between the rows of blower units to selectively exhaust air expelled from the blower units through exhaust holes formed at regular intervals, and
an opening and closing unit to open or close the exhaust holes of the exhaust support plates as a function of the thickness of the glass pane being transported.

2. The air-floating transfer apparatus of claim 1, wherein
the blower units comprise:
an air distribution member that allows air to be evenly distributed by the operation of the air pump, and
multiple blower holes formed in a transverse direction and coupled to and arranged on the leading edge of the air distribution member, wherein the blower holes communicate with the air distribution member, forming a blower support plate.

3. The air-floating transfer apparatus of claim 1, wherein
the opening and closing unit comprises:
a cylinder driven by input signals,
a rod that ascends or descends a certain distance by the operation of the cylinder,
multiple links coupled to the rod allowing rotation, and
multiple opening and closing plates, each having one end pivotally coupled to the respective link and the other end pivotally coupled to the exhaust support plate.

4. The air-floating transfer apparatus of claim 3, wherein
the opening and closing unit comprises:
at least one support bracket installed on the surface of at least one of the plurality of exhaust support plates to guide the linear movement of the rod, and
a pair of guide rollers installed on the support bracket to guide the linear movement of the rod.

5. The air-floating transfer apparatus of claim 1, wherein
the opening and closing unit (i) opens the exhaust holes of the exhaust support plate when the glass pane being transported is below the set thickness and (ii) closes the exhaust holes of the exhaust support plate when the glass pane being transported is above the set thickness.

6. An air-floating transfer apparatus comprising:
a conveyor belt configured to convey a glass pane;
an air pump configured to supply air;
multiple rows of air blowing units configured to receive the air from the air pump and discharge the air toward a primary surface of the glass pane; and
multiple rows of exhaust support plates, each (i) comprising exhaust holes and (ii) arranged between two of the multiple rows of air blowing units so that the multiple rows of air blowing units and the multiple rows of exhaust support plates alternate position moving away from the conveyor belt, the multiple rows of exhaust support plates configured to selectively (i) open to accept air discharged from the multiple rows of air blowing units through the exhaust holes or (ii) close to not accept the air;
wherein, the multiple rows of exhaust supports plates and the multiple rows of air blowing units form a substantially planar glass facing surface, the substantially planar glass facing surface positioned at a predetermined angle from vertical.

7. The air-floating transfer apparatus of claim 6 further comprising:
support brackets that support the multiple rows of exhaust support plates and the multiple rows of air blowing units.

8. The air-floating transfer apparatus of claim 6, wherein
each of the multiple rows of air blow units comprise (i) an air distribution member configured to evenly distribute air from the air pump, (ii) a blowing support plate disposed at a glass-facing edge of the air distribution member, and (iii) multiple airflow holes through the blowing support plate.

9. The air-floating transfer apparatus of claim 6, wherein
each of the exhaust support plates comprise multiple of the exhaust holes.

10. The air-floating transfer apparatus of claim 6 further comprising:
a control mechanism for selectively opening and closing the exhaust holes of the exhaust support plates as a function of a thickness of the glass pane to be conveyed on the conveyor belt.

11. The air-floating transfer apparatus of claim 10, wherein
the control mechanism is configured to open the exhaust holes of the exhaust support plates when the glass pane to be conveyed is thinner than a set thickness, and
the control mechanism is configured to close the exhaust holes of the exhaust support plates when the glass pane to be conveyed is thicker than a set thickness.

12. The air-floating transfer apparatus of claim 11, wherein
the control mechanism comprises:
a cylinder configured to be driven by input signals;
a rod that is manipulated by operation of the cylinder;
multiple links coupled to the rod for rotation; and
multiple opening and closing plates, each of which is coupled to (i) a different one of the exhaust support plates and (i) at least one of the multiple links.

13. The air-floating transfer apparatus of claim 12, wherein
each of the multiple opening and closing plates are hinged at a lower end to a side of the exhaust support plate configured to face away from the glass pane and at an upper end to the at least one of the multiple links.

14. The air-floating transfer apparatus of claim 12, wherein
as the rod is lifted via movement of the cylinder, the multiple links rotate and thereby cause the multiple opening and closing plates to rotate as well.

15. The air-floating transfer apparatus of claim 14, wherein
rotation of the multiple opening and closing plates selectively opens or closes the exhaust holes of the exhaust support plates.

16. The air-floating transfer apparatus of claim 12, wherein
the control mechanism further comprises:
support brackets coupled to the surface of each of the exhaust support plates positioned to face away from the glass pane; and
guide rollers installed on the support brackets to guide the manipulation of the rod.

17. The air-floating transfer apparatus of claim 12, wherein
the control mechanism further comprises a control unit configured send the input signals to the cylinder to manipulate the rod as a function of a thickness of the glass pane to be conveyed by the conveyor.

18. The air-floating transfer apparatus of claim 17, wherein
the control unit is configured to send the input signal to the cylinder to manipulate the rod so that the exhaust holes of the exhaust support plates are open when the glass pane to be conveyed is thinner than a set thickness.

19. The air-floating transfer apparatus of claim 18, wherein
the control unit is configured to send the input signal to the cylinder to manipulate the rod so that the exhaust holes of the exhaust support plates are closed when the glass pane to be conveyed is thicker than the set thickness.

20. A method of conveying glass panes comprising:
a thin glass pane conveyance step comprising conveying a thin glass pane on the air-floating transfer apparatus of claim 6, with an edge of the thin glass pane on the conveyor belt, and a primary surface of the thin glass pane tilted at an angle deviating from vertical facing the multiple rows of air blowing units and the multiple rows of exhaust support plates,
wherein, during the thin glass conveyance step, (i) the air pump is supplying air, (ii) the air blowing units are receiving the air from the air pump and discharging the air toward the primary surface of the thin glass pane, (iii) the exhaust holes of the exhaust support plates are open, (iv) the air discharged from the air blowing units separate the thin glass pane from the air blowing units and the exhaust support plates, and (v) a portion of the air discharged from air blowing units flow between the glass pane and the exhaust support plate and into the exhaust holes:
a closing step comprising closing the exhaust holes of the exhaust support plates after the thin glass pane has cleared the air-floating transfer apparatus;
a thick glass conveyance step comprising conveying a thick glass pane, which is thicker the thin glass pane, on the air-floating transfer apparatus, with an edge of the thick glass pane on the conveyor belt, and a primary surface of the thick glass pane tilted at an angle deviating from vertical facing the multiple rows of air blowing units and the multiple rows of exhaust support plates,
wherein, during the thick glass conveyance step, (i) the air pump is supplying air, (ii) the air blowing units are receiving the air from the air pump and discharging the air toward the primary surface of the thick glass pane, (iii) the exhaust holes of the exhaust support plates are closed, (iv) the air discharged from the air blowing units separate the thick glass pane from the air blowing units and the exhaust support plates, and (v) the air discharged from air blowing units flow primarily between the thick glass pane and the multiple rows of air blowing units and the multiple rows of exhaust support plates without flowing through the exhaust holes; and
an opening step comprising opening the exhaust holes of the exhaust support plates after the thick glass pane has cleared the air-floating transfer apparatus.

21. The method of claim 20, wherein
the thickness of thin glass pane is within a range of from 0.3 mm to 2.0 mm.

22. The method of claim 20, wherein
the thickness of the thick glass pane is greater than 5 mm.

23. The method of claim 20, wherein
the thickness of the thick glass pane within a range of from 2.0 mm to 5.0 mm.

24. A method of conveying glass panes of differing thicknesses comprising:
a thin glass pane conveyance step comprising:
conveying, with a transfer apparatus, a thin glass pane comprising a thickness less than a preset thickness by disposing an edge of the thin glass pane on a conveyor belt,
moving the conveyor belt with the thin glass pane thereupon,
directing air toward a primary surface of the thin glass pane with sufficient volume so that the primary surface of the thin glass pane does not touch a solid surface and the primary surface of the thin glass pane floats while moving upon the air, and
exhausting a portion of the volume of the air through exhaust holes facing the primary surface of the thin glass pane:
after the thin glass pane has cleared the transfer apparatus, a closing step comprising closing the exhaust holes;
a thick glass pane conveyance step comprising:
conveying, with a transfer device, a thick glass pane comprising a thickness greater than a preset thickness by disposing an edge of the thick glass pane on a conveyor belt,
moving the conveyor belt with the thick glass pane thereupon, and
directing air toward a primary surface of the thick glass pane with sufficient volume so that the primary surface of the thick glass pane does not touch a solid surface and the primary surface of the thick glass pane floats while moving upon the air; and
after the thick glass pane has cleared the transfer apparatus, an opening step comprising opening the exhaust holes.

25. The method of claim 24, wherein
the volume of air directed to the primary surface of the thin glass pane during thin glass pane conveyance step is substantially the same as the volume of air directed to the primary surface of the thick glass pane during the thick glass pane conveyance step.

26. The method of claim 24, wherein
the thickness of thin glass pane is within a range of from 0.3 mm to 2.0 mm.

27. The method of claim 24, wherein
the thickness of the thick glass pane within a range of from 2.0 mm to 5.0 mm.

28. A system for manufacturing IGUs comprising:
a glass supply unit configured to supply glass panes of set thicknesses for forming inner glass, outer glass, or intermediate glass of an IGU in a predetermined sequence controlled by control signals;
a washing and drying unit downstream of the glass supply unit configured to sequentially wash and dry the glass panes supplied from the glass supply unit; and
the air-floating transfer apparatus of claim 1 downstream of the washing and drying unit.

29. The system of claim 28 further comprising:
a spacer coating unit downstream of the air-floating transfer apparatus configured to apply sealant material as a spacer to one or more of the supplied glass panes.

30. The system of claim 29 further comprising:
an inspection unit downstream of the sealant spacer coating unit configured to inspect the glass panes.

31. The system of claim 30 further comprising:
an alignment unit configured to realign any of the glass panes to be bonded together that need realignment;
aa bonding unit configured to bond two or more of the glass panes together with a space between adjacent glass panes and add a gas in the space, thus forming an IGU; and
a sealing unit configured to apply a secondary sealant onto the IGU.
